(19) United States
(12) Patent Application Publication
(10) Pub. No.: US 2016/0179149 A1
(43) Pub. Date: Jun. 23, 2016

(54) DYNAMIC COOLING FOR ELECTRONIC DEVICES

(71) Applicant: Intel Corporation, Santa Clara, CA (US)

(72) Inventors: JOHN J. VALAVI, Beaverton, OR (US); JAMES R. TRETHEWEY, Hillsboro, OR (US); VASUDEVAN SRINIVASAN, Hillsboro, OR (US); DOUG HEGGE, Vancouver, WA (US)

(73) Assignee: Intel Corporation, Santa Clara, CA (US)

(21) Appl. No.: 14/580,065

(22) Filed: Dec. 22, 2014

(51) Int. Cl. G06F 1/20

(52) U.S. Cl. CPC G06F 1/206; G06F 1/203

(57) ABSTRACT

In one example a electronic device comprises at least one heat generating component, a thermal management module comprising logic, at least partly including hardware logic, to receive a signal from the sensor indicating that the electronic device is coupled to an external device, receive thermal dissipation capability data from the external device, and update a thermal management platform for the electronic device to accommodate the thermal dissipation capability data received from the external device. Other examples may be described.

### RELATED APPLICATIONS

None.

### BACKGROUND

The subject matter described herein relates generally to the field of electronic devices and more particularly to a dynamic cooling for electronic devices.

Electronic devices such as laptop computers, tablet computing devices, electronic readers, mobile phones, and the like may include heat generating components, e.g., integrated circuits, displays, and the like. The performance of such electronic devices may be limited by heat dissipation capabilities of the electronic devices. To accommodate limitations in heat dissipation, electronic devices may be designed to operate their various subsystems in accordance with operating guidelines that manage power consumption by various subsystems. Such guidelines are sometimes referred to as thermal design operating points (TDPs) or thermal design management algorithms and may include various operating settings populated in tables such as advanced configuration and power interface (ACPI) table accessible by the device Basic Input/Output System (BIOS).

Most electronic devices are designed with fixed thermal design operating point (TDP) established during testing of the device. It may be useful in some instances to accommodate changes in heat dissipation capabilities for electronic devices. Accordingly, techniques which enable an electronic device to implement a flexible or dynamic thermal design operating point (TDP) may find utility.

### BRIEF DESCRIPTION OF THE DRAWINGS

The detailed description is described with reference to the accompanying figures.

FIG. 1 is a schematic illustration of an environment in which dynamic cooling for electronic devices may be implemented in accordance with some examples.

FIG. 2 is a schematic illustration of electronic devices which may be adapted to include dynamic cooling for electronic devices in accordance with some examples.

FIG. 3 is a schematic illustration of an external device which may be adapted to include dynamic cooling for electronic devices in accordance with some examples.

FIGS. 4A-4B are schematic illustrations of components which may be adapted to include dynamic cooling for electronic devices in accordance with some examples.

FIG. 5 is a flowchart illustrating operations in a method to implement dynamic cooling for electronic devices in accordance with some examples.

FIGS. 6-10 are schematic illustrations of electronic devices which may be adapted to implement dynamic cooling for electronic devices in accordance with some examples.

### DETAILED DESCRIPTION

Described herein are exemplary systems and methods to implement dynamic cooling in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

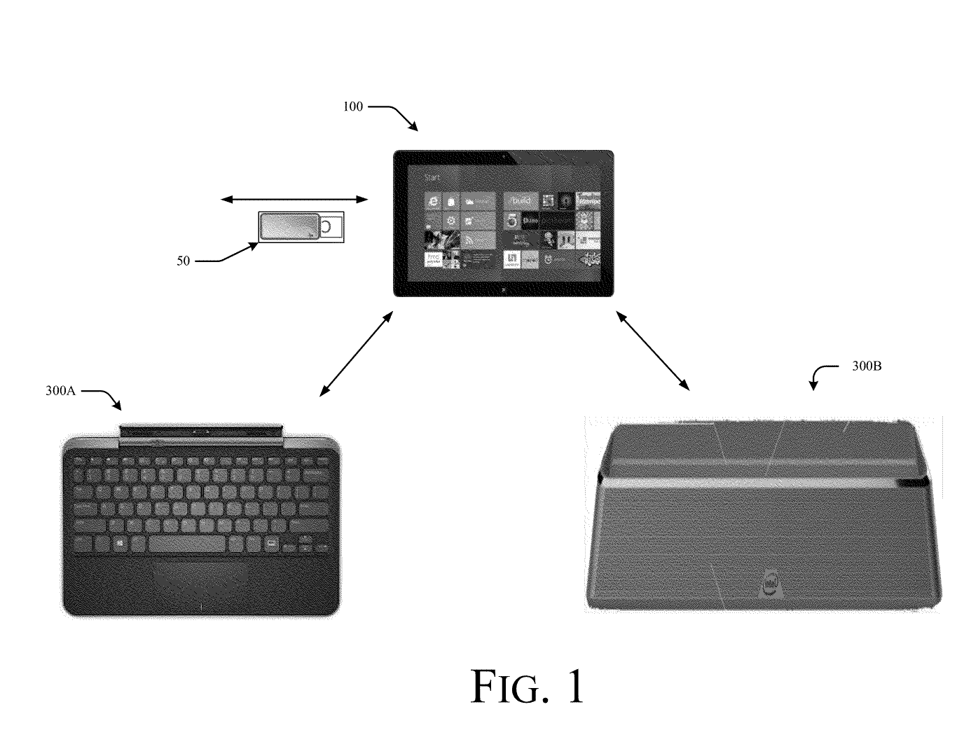

FIG. 1 is a schematic illustration of an environment in which dynamic cooling for electronic devices may be implemented in accordance with some examples. Referring to FIG. 1, an electronic device 100 may be operating in multiple different operating environments. For example, the electronic device 100 may be operated in a stand-alone mode or may be coupled to a remote memory device 50. Alternatively, electronic device 100 may be coupled to an external device such as an external docking device 300A on a keyboard device or an external docking device 300B which functions as a media console. External devices 300A, 300B may be referred to collectively herein by reference numeral 300.

Each operating mode for the electronic device 100 may be characterized by different work requirements. Further, the respective external devices 300A, 300B may have different thermal dissipation capabilities. For example, the keyboard external device 300A may comprise only passive heat dissipation capabilities such as one or more heat spreaders or the like. By contrast, the external device 300B may comprise active heat dissipation capabilities such as one or more fans, radiator systems, or the like.

Described herein are techniques which enable the electronic device 100 to detect when it is coupled to an external device 300, to determine a thermal dissipation capability of the external device 300, and to update a thermal management platform for the electronic device 100 to accommodate the thermal dissipation capability of the external device 300. Similarly, described herein are techniques which enable the external device 300 to detect that an electronic device 100 has been coupled to the external device 300, receive a request for thermal dissipation capability data from the electronic device 100, and to forward thermal dissipation capability data to the electronic device 100.

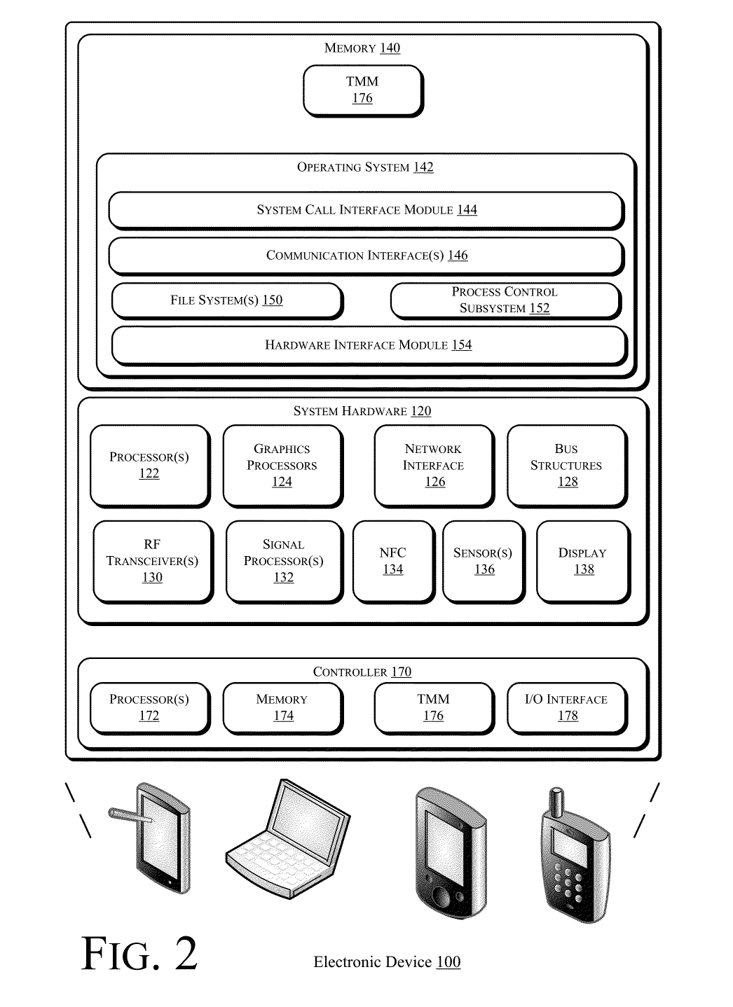

FIG. 2 is a schematic illustration of electronic devices which may be adapted to include dynamic cooling for electronic devices in accordance with some examples. Referring first to FIG. 2, in various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more sensors 136 such as a thermal sensor, a coupling sensor, or the like. Electronic device 100 may further include one or more input/output interfaces such as, e.g., a keypad 136 and a display 138. In some examples electronic device 100 may not have a keypad and use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may be logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms.

In the embodiment depicted in FIG. 2 the controller 170 comprises a processor 172, a memory module 174, a thermal management unit (TMM) 176, and an I/O interface 178. In some examples the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples portions of the thermal management unit 176 may reside in the memory 140 of electronic device 100 and may be executable on one or more of the processors 122.

In some examples the thermal management unit 176 interacts with one or more other components of the electronic device 100 to assess changes in the thermal dissipation capabilities of the electronic device 100 and to manage the thermal platform management algorithms to accommodate such changes.

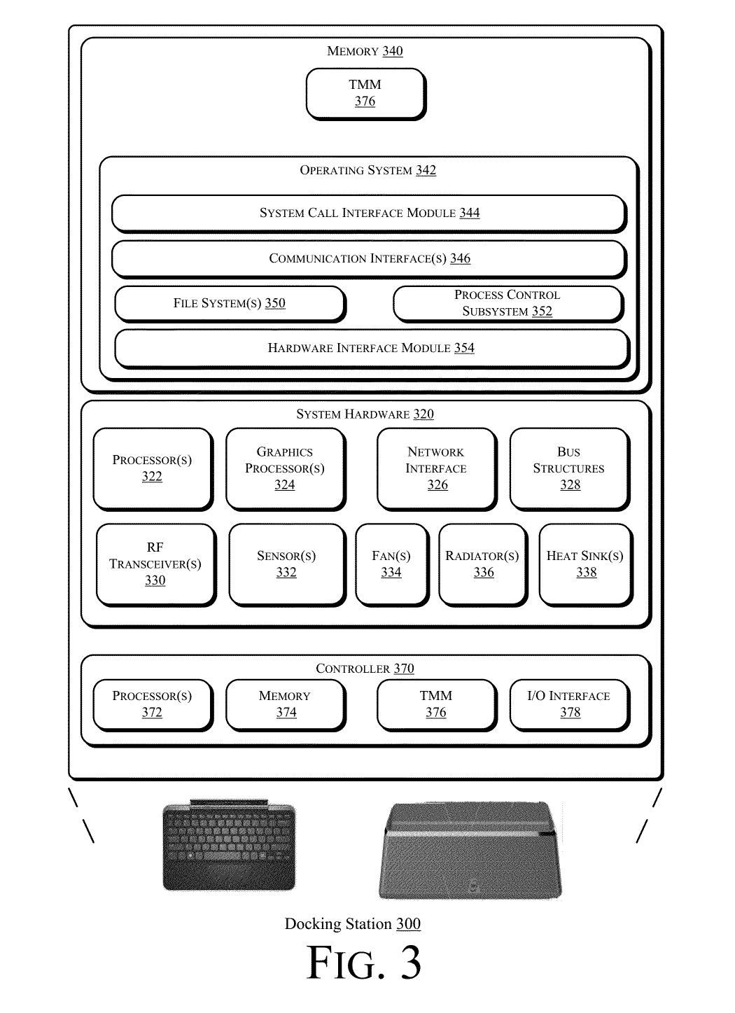

FIG. 3 is a schematic illustration of an external device 300 which may be adapted to include dynamic cooling for electronic devices 100 in accordance with some examples. The specific features included in an external device 300 may depend upon the functionality of the external device 300. For example, the external device 300A may have relatively few features, while external device 300B may be a fully featured media device. The following description is provided as one example.

Referring to FIG. 3, in various examples, external device 300 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the external device 300 to receive input from a user.

The external device 300 includes system hardware 320 and memory 340, which may be implemented as random access memory and/or read-only memory. A file store may be communicatively coupled to external device 300. The file store may be internal to external device 300 such as, e.g., eMMC, SSD, one or more hard drives, or other types of storage devices. Alternatively, the file store may also be external to external device 300 such as, e.g., one or more external hard drives, network attached storage, or a separate storage network.

System hardware 320 may include one or more processors 322, graphics processors 324, network interfaces 326, and bus structures 328. In one embodiment, processor 322 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 324 may function as adjunct processor that manages graphics and/or video operations. Graphics processor(s) 324 may be integrated onto a motherboard of external device 300 or may be coupled via an expansion slot on the motherboard or may be located on the same die or same package as the processor(s) 322.

In one embodiment, network interface 326 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 328 connect various components of system hardware 328. In one embodiment, bus structures 328 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

External device 300 may include an RF transceiver 330 to transceive RF signals. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

External device 300 may further include one or more sensors 332 such as a thermal sensor, a coupling sensor, or the like. For example, sensor(s) 332 may comprise a sensor to detect when an electronic device 100 is coupled to the docking station 300. Sensor(s) 332 may further include one or more thermal sensors to detect a temperature in one or more regions inside the docking station 300.

External device 300 may further include one or more thermal dissipation devices such as, e.g., one or more fans 334, radiators 336, or heat sinks 338.

Memory 340 may include an operating system 342 for managing operations of external device 300. In one embodiment, operating system 342 includes a hardware interface module 354 that provides an interface to system hardware 320. In addition, operating system 340 may include a file system 350 that manages files used in the operation of external device 300 and a process control subsystem 352 that manages processes executing on external device 300.

Operating system 342 may include (or manage) one or more communication interfaces 346 that may operate in conjunction with system hardware 320 to transceive data packets and/or data streams from a remote source. Operating system 342 may further include a system call interface module 344 that provides an interface between the operating system 342 and one or more application modules resident in memory 330. Operating system 342 may be embodied as a UNIX operating system or any derivative thereof (e.g., Linux, Android, etc.) or as a Windows® brand operating system, or other operating systems.

In some examples an external device may include a controller 370, which may comprise one or more controllers that are separate from the primary execution environment. The separation may be physical in the sense that the controller may be implemented in controllers which are physically separate from the main processors. Alternatively, the trusted execution environment may be logical in the sense that the controller may be hosted on same chip or chipset that hosts the main processors.

By way of example, in some examples the controller 370 may be implemented as an independent integrated circuit located on the motherboard of the external device 300, e.g., as a dedicated processor block on the same SOC die. In other examples the trusted execution engine may be implemented on a portion of the processor(s) 322 that is segregated from the rest of the processor(s) using hardware enforced mechanisms.

In the embodiment depicted in FIG. 3 the controller 370 comprises a processor 372, a memory module 374, a thermal management unit (TMM) 376, and an I/O interface 378. In some examples the memory module 374 may comprise a persistent flash memory module and the various functional modules may be implemented as logic instructions encoded in the persistent memory module, e.g., firmware or software. The I/O module 378 may comprise a serial I/O module or a parallel I/O module. Because the controller 370 is separate from the main processor(s) 322 and operating system 342, the controller 370 may be made secure, i.e., inaccessible to hackers who typically mount software attacks from the host processor 322. In some examples portions of the thermal management unit 376 may reside in the memory 340 of external device 300 and may be executable on one or more of the processors 322.

FIG. 2 is a high-level schematic illustration of an exemplary architecture to implement a thermal management unit 176 in electronic devices. Referring to FIG. 2, a controller 220 may be embodied as a general purpose processor 122 or as a low-power controller such as controllers 170. Controller 220 may comprise an thermal management unit 176 and a local memory 260. As described above, in some examples the thermal management unit 176 may be implemented as logic instructions executable on controller 220, e.g., as software or firmware, or may be reduced to hardwired logic circuits. Local memory 260 may be implemented using volatile and/or non-volatile memory.

Controller 220 may be communicatively coupled to one or more local devices input/output (I/O) devices which provide signals that provide information about the operating environment in which electronic device 100 operates. For example, the thermal management unit 176 in controller 220 may be communicatively coupled to one or more thermal sensors 232. Similarly, thermal management unit 176 may be coupled to one or more coupling sensors 234.

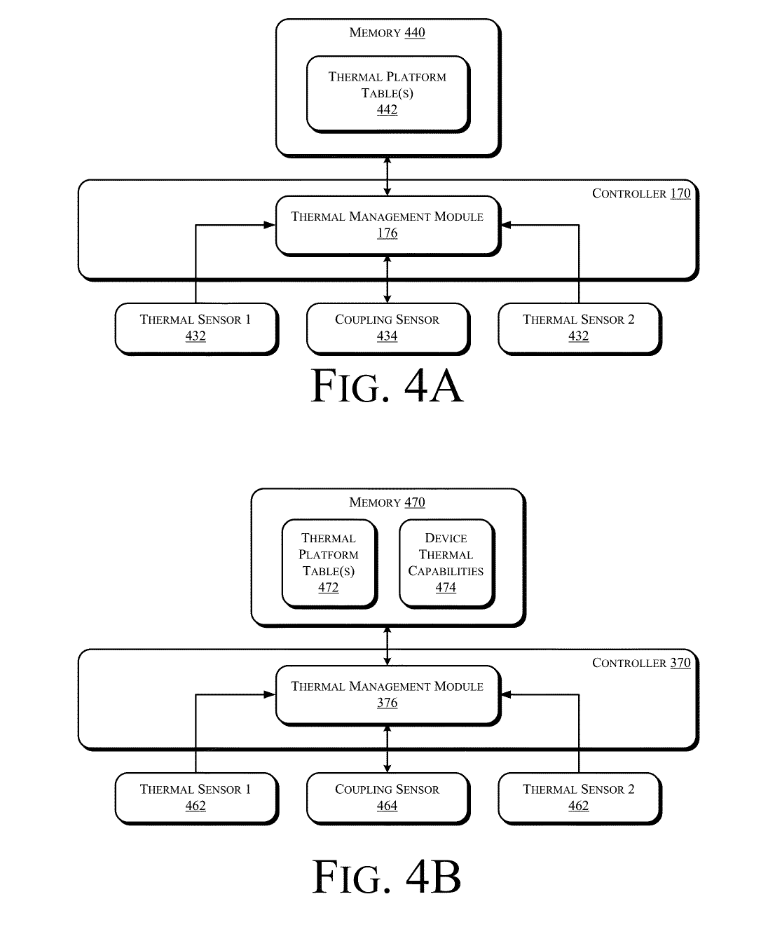

FIGS. 4A-4B are schematic illustrations of components which may be adapted to include dynamic cooling for electronic devices in accordance with some examples. More particularly, FIG. 4A depicts an architecture for a controller-based implementation of an electronic device 100 adapted to include dynamic cooling, while FIG. 4B depicts an architecture for a controller-based implementation of an external device adapted to include dynamic cooling.

Referring first to FIG. 4A, in some examples the controller 170 on the electronic device 100 includes logic, at least partially including hardware logic, which defines the thermal management module 176. The thermal management module 176 is communicatively coupled, e.g., via input/output interface(s) to a coupling sensor 434 and to one or more thermal sensors 432. Memory 440 may comprise one or more thermal platform tables 442 which specify operating parameters (e.g., power settings, processor speeds, display settings, etc.) for the electronic device 100. For example, thermal platform tables 442 may comprise a native thermal platform table which designates operating parameter for the electronic device 100 and which may be retrieved from memory 440 by the basic input/output system (BIOS) of electronic device 100 when the device is booted. Thermal platform tables 442 may include additional tables which may be invoked during operation of the electronic device 100.

Referring to FIG. 4B, in some examples a controller 370 on the external device 300 includes logic, at least partially including hardware logic, which defines a thermal management module 376. The thermal management module 376 is communicatively coupled, e.g., via input/output interface(s) to a coupling sensor 464 and to one or more thermal sensors 462. Memory 470 may comprise one or more thermal platform tables 472 which specify operating parameters (e.g., power settings, processor speeds, display settings, etc.) for the external device 300. For example, thermal platform tables 472 may comprise a native thermal platform table which designates operating parameter for the external device 300 and which may be retrieved from memory 470 by the basic input/output system (BIOS) of external device 300 when the device is booted. Thermal platform tables 442 may include additional tables which may be invoked during operation of the external device 300.

Memory 470 may further include one or more device thermal capabilities 474. For example, thermal capabilities 474 may describe the thermal dissipation capability of one or more of the thermal dissipation devices such as the fan(s) 334, radiator(s) 336, or heat sink(s) 338 on external device 300.

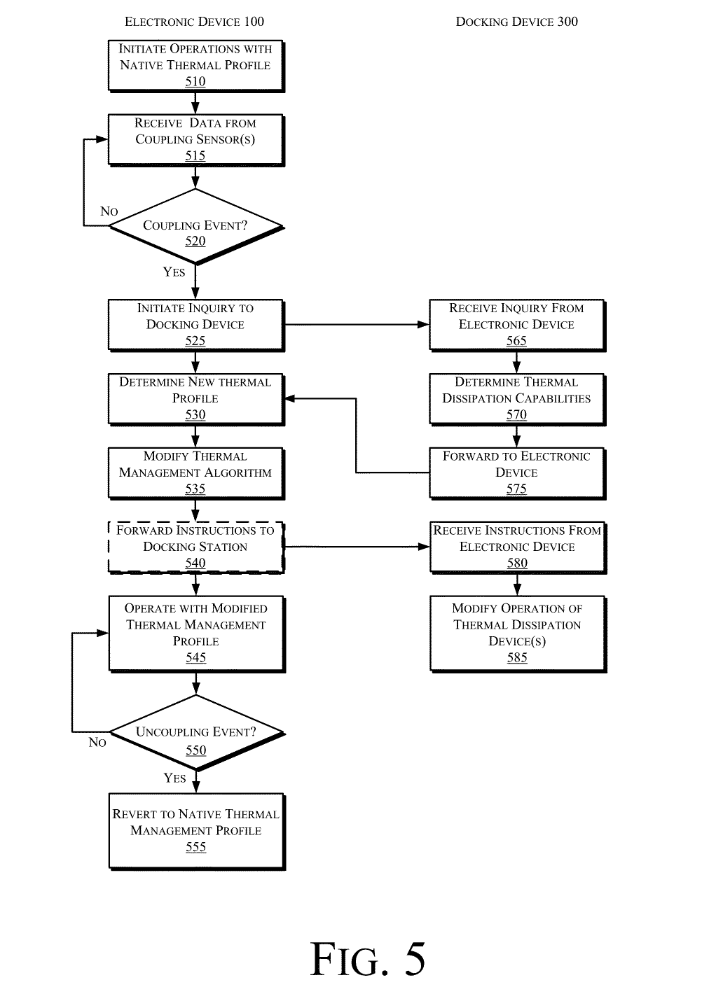

Having described various structures of a system to implement a dynamic cooling for electronic devices, operating aspects of a system will be explained with reference to FIG. 5, which is a flowchart illustrating operations in a method to implement dynamic cooling for electronic devices in accordance with some examples. The operations depicted on the left side of the flowchart of FIG. 5 may be implemented by the thermal management unit 176, alone or in combination with other component of electronic device 100. The operations depicted on the right side of the flowchart of FIG. 5 may be implemented by the thermal management unit 376, alone or in combination with other component of external device 300

In some examples the thermal management module 176 on the electronic device 100 cooperates with the thermal management module 376 on the docking station in order to facilitate dynamic cooling of electronic device 100. Referring to FIG. 5, at operation 510 the electronic device 100 initiates operations with a native thermal profile. For example, as described above, in some examples the BIOS of electronic system 100 may retrieve a native thermal profile from the thermal platform table(s) 442 in memory 440 when electronic device 100 is booted.

At operation 515 the thermal management module 176 receives data from the coupling sensor(s) 434. At operation 515 it is determined whether there was a coupling event. For example, if at operation 515 the output of the coupling sensor 434 indicates that the electronic device 100 has been coupled to the external device 300 then the output of the coupling sensor 434 would indicate that a coupling event has taken place. In some examples the electronic device 100 may be coupled to the external device 300 via a standardized protocol such as a Universal Serial Bus (USB) connector or the like. If at operation 520 the output of the coupling sensor 434 indicates that that a coupling event has not occurred then control passes back to operation 515 and the thermal management module 176 continued to receive data from the coupling sensor(s) 434.

By contrast, if at operation 520 a coupling event is indicated then control passes to operation 525 and the thermal management unit 176 initiates an inquiry to the external device 300 to request one or more thermal capabilities from the external device 300.

At operation 565 the external device 300 receives the inquiry from the electronic device 100 and at operation 570 the external device 300 determines thermal dissipation capabilities of the thermal dissipation devices on external device 300. For example, thermal management module 376 may query the device thermal capabilities table 474 in memory 470 to determine thermal dissipation capabilities of thermal dissipation devices such as the fans 334, radiator(s) 336 and/or heat sink(s) 338 on external device 300. At operation 575 the external device 300 forwards the thermal dissipation capabilities of the external device 300 to the electronic device 100.

The electronic device 100 receives the thermal dissipation capabilities from the external device 300 and at operation 530 the thermal management module 176 in the electronic device 100 determines a new thermal profile. By way of example the thermal management module 176 may select a new thermal platform from the thermal platform table(s) 442 in memory based at least in part on the thermal dissipation capabilities received from the docking station. At operation 535 the new thermal platform may modify the operation of one or more components of electronic device 100 in response to increased thermal dissipation capacity provided by the external device 300.

Optionally, at operation 540 the thermal management module 176 in the electronic device 100 may forward instructions to the external device 300. For example, the thermal management module 176 may instruct the external device 300 to alter one or more aspects of components of external device 300 in order to generate more thermal dissipation capacity for external device 300.

At operation 580 the external device 300 receives the instructions from the electronic device 100 and at operation 585 the external device modifies operation of one or more thermal dissipation device(s) in the external device. In some examples the thermal management module 376 in external device 300 may increase an operating speed of one or more fans 334 or the flow rate of fluid in one or more radiators 336 in external device. Alternatively, or in addition, the thermal management module 376 may decrease an operating speed of one or more processor(s) 372 or other electronic components on external device 300 in order to reduce the heat generated by the processor(s) 372 or other electronic components of external device 300, thereby freeing more of the thermal dissipation capacity of external device for use by the electronic device 100.

At operation 545 the electronic device 100 operates with a modified thermal management profile, and at operation 550 it is determined whether there was an uncoupling event. For example, if at operation 550 the output of the coupling sensor 434 indicates that the electronic device 100 has been uncoupled from the external device 300 then the output of the coupling sensor 434 would indicate that an uncoupling event has taken place. If at operation 550 the output of the coupling sensor 434 indicates that that an uncoupling event has not occurred then control passes back to operation 545 and the thermal management module 176 continues to receive data from the coupling sensor(s) 434.

By contrast, if at operation 550 an uncoupling event is indicated then control passes to operation 555 and the thermal management unit 176 reverts to the native thermal management profile for the electronic device 100.

Thus, the structure and operations described herein enable the thermal management unit 176 to implement a dynamic thermal management algorithm for the electronic device 100 depending upon the heat dissipation capabilities available in the external device 300 to dissipate heat from the electronic device 100. When the electronic device 100 is operating in a stand-alone environment it may operate according to a first thermal management algorithm. However, when the electronic device is coupled to an external heat dissipation device, e.g., in an external device 300, then the device may be operating in accordance with a different thermal management algorithm.

In some examples communication between the electronic device 100 and the external device may be implemented via a human interface device (HID) protocol over a type C sideband channel on a USB connection. This allows the capability inquiry to be made via a HID Get Descriptor technique to fetch the HID Report Descriptor of the thermal capabilities device(s) on the external device 300. The thermal capabilities may include information such as a number of cooling devices on the external device, an identifying tag for each device, a type of each device (e.g., fan, heat spreader, heat exchanger, water radiator, liquid nitrogen, etc.), the power consumption of the cooling devices, and one or more thermal zones in the external device. The electronic device 100 may perform an HID Descriptor Parsing operation to retrieve the data from the response from the external device 300.

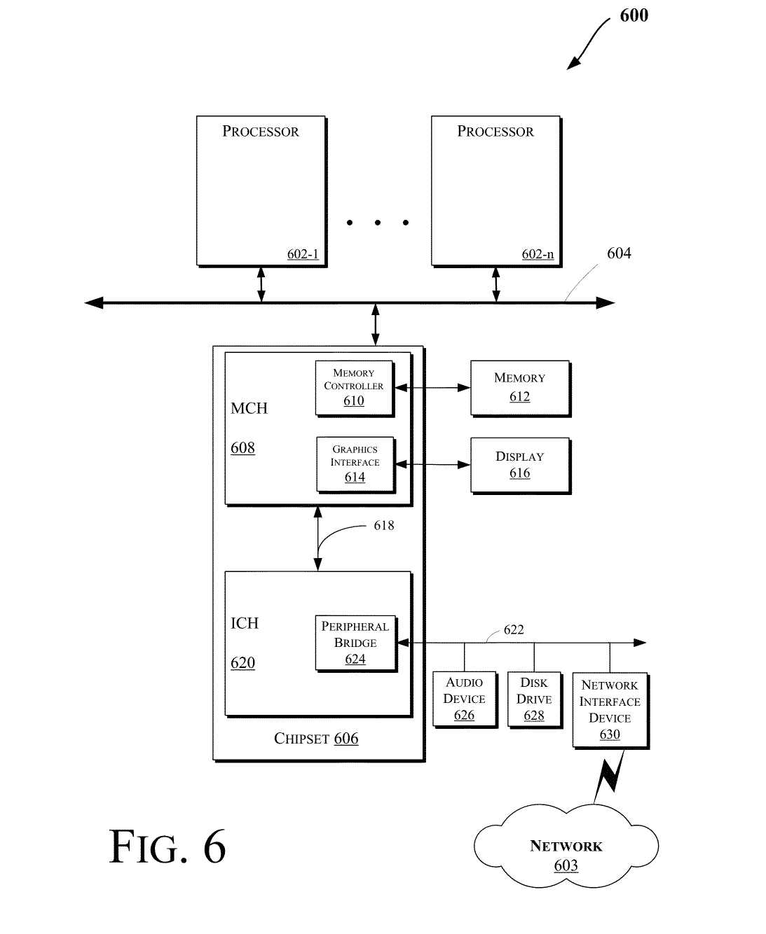

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

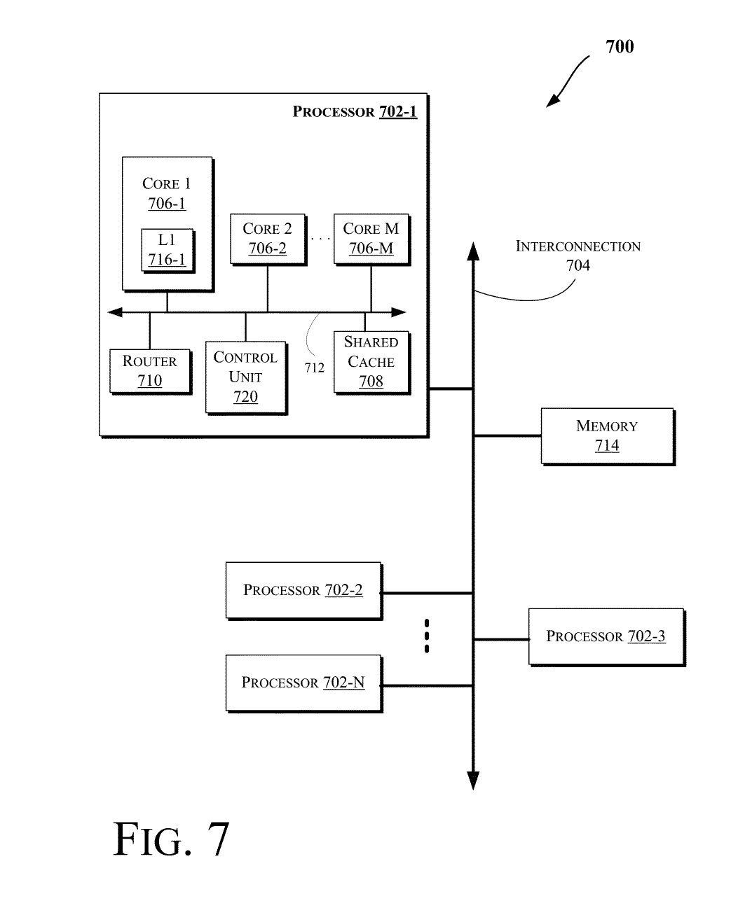

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

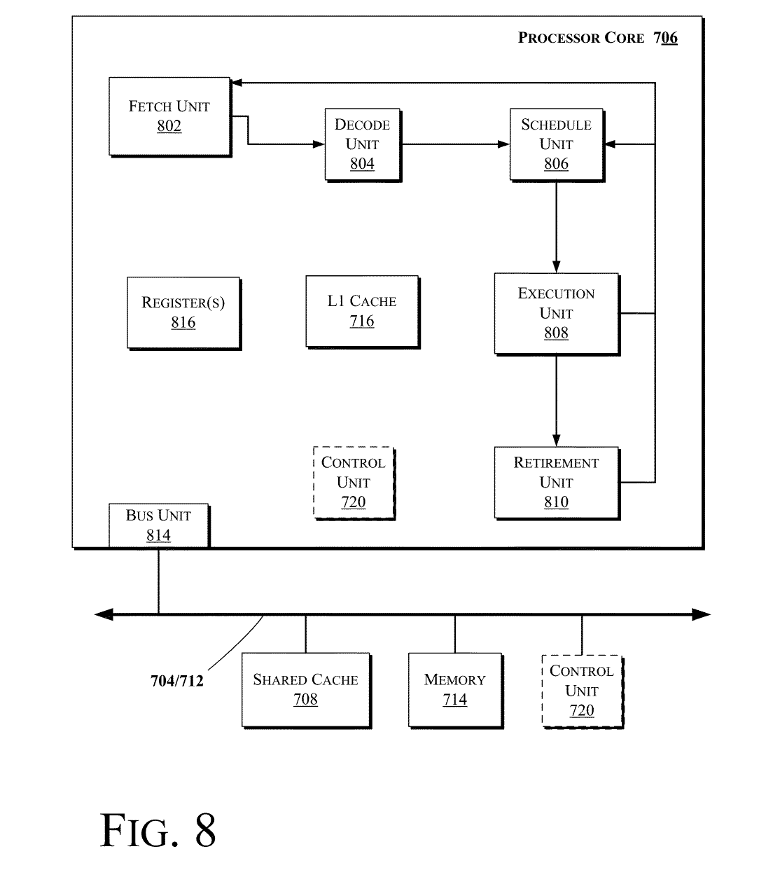

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

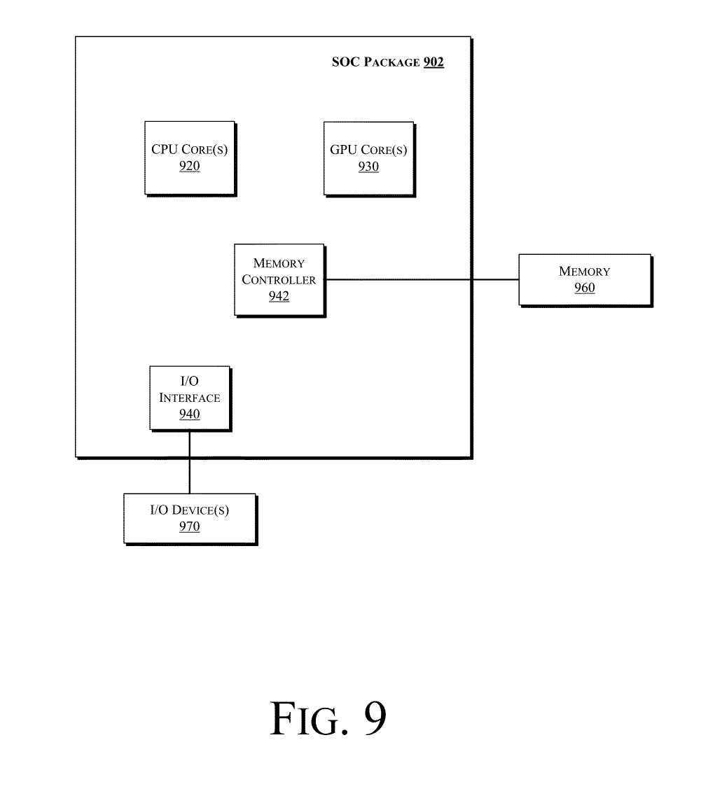

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

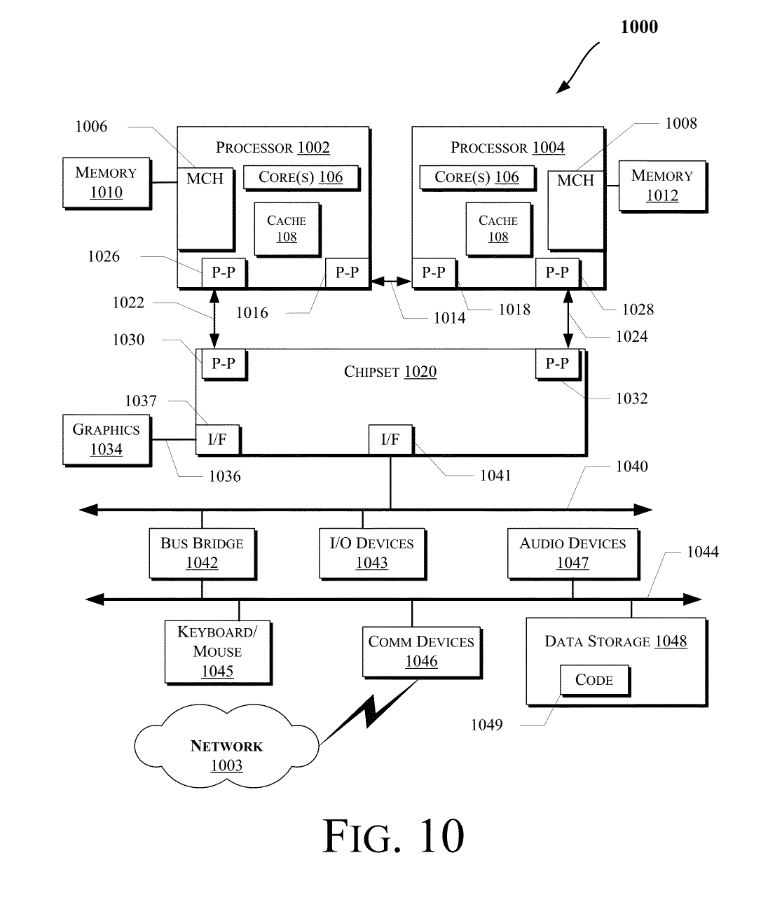

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further examples.

Example 1 is an electronic device, comprising at least one heat generating component, a thermal management module comprising logic, at least partly including hardware logic, to receive a signal from the sensor indicating that the electronic device is coupled to an external device, receive thermal dissipation capability data from the external device, and update a thermal management platform for the electronic device to accommodate the thermal dissipation capability data received from the external device.

In Example 2, the subject matter of Example 1 can optionally include an arrangement in which the electronic device couples to the external device via a universal serial bus (USB) interface.

In Example 3, the subject matter of any one of Examples 1-2 can optionally include an arrangement in which in response to the signal from the sensor, the thermal management module initiates an inquiry to the external device.

In Example 4, the subject matter of any one of Examples 1-3 can optionally include an arrangement in which the inquiry is initiated using a human interface device (HID) protocol via a sideband channel on the USB interface.

In Example 5, the subject matter of any one of Examples 1-4 can optionally an arrangement in which the thermal dissipation capability data comprises at least one of a number of cooling devices associated with the external device, an identifying tag associated with at least one of the number of cooling devices, a cooling capability of at least one of the number of cooling devices, a power consumption of at least one of the number of cooling devices, a thermal zone sensor for at least one of the number of cooling devices.

In Example 6, the subject matter of Examples 1-5 can optionally include logic, at least partly including hardware logic, to transmit a thermal management instruction to the external device.

In Example 7, the subject matter of any one of Examples 1-6 can optionally include logic, at least partly including hardware logic, to receive a signal from the sensor indicating that the electronic device is uncoupled from an external device and update a thermal management platform for the electronic device to accommodate removal of the thermal dissipation capability data received from the external device.

Example 8 is a controller for an electronic device comprising logic, at least partly including hardware logic, to receive a signal from a sensor indicating that the electronic device is coupled to an external device, receive thermal dissipation capability data from the external device, and update a thermal management platform for the electronic device to accommodate the thermal dissipation capability data received from the external device.

In Example 9, the subject matter of Example 8 can optionally include an arrangement in which the electronic device couples to the external device via a universal serial bus (USB) interface.

In Example 10, the subject matter of any one of Examples 8-9 can optionally include an arrangement in which in response to the signal from the sensor, the thermal management module initiates an inquiry to the external device.

In Example 11, the subject matter of any one of Examples 8-10 can optionally include an arrangement in which the inquiry is initiated using a human interface device (HID) protocol via a sideband channel on the USB interface.

In Example 12, the subject matter of any one of Examples 8-11 can optionally an arrangement in which the thermal dissipation capability data comprises at least one of a number of cooling devices associated with the external device, an identifying tag associated with at least one of the number of cooling devices, a cooling capability of at least one of the number of cooling devices, a power consumption of at least one of the number of cooling devices, a thermal zone sensor for at least one of the number of cooling devices.

In Example 13, the subject matter of Examples 8-12 can optionally include logic, at least partly including hardware logic, to transmit a thermal management instruction to the external device.

In Example 14, the subject matter of any one of Examples 8-13 can optionally include logic, at least partly including hardware logic, to receive a signal from the sensor indicating that the electronic device is uncoupled from an external device and update a thermal management platform for the electronic device to accommodate removal of the thermal dissipation capability data received from the external device.

Example 15 is an external device for an electronic device, comprising a housing, at least one heat dissipation component disposed within the housing, a controller comprising logic, at least partly including hardware logic, to detect than an electronic device is coupled to the external device, receive a request for thermal dissipation capability data from the electronic device, and in response to the request, to forward thermal dissipation capability data from the external device to the electronic device.

In Example 16, the subject matter of Example 16 can optionally include an arrangement in which the electronic device couples to the external device via a universal serial bus (USB) interface.

In Example 17, the subject matter of any one of Examples 15-16 can optionally include an arrangement in which the thermal dissipation capability data comprises at least one of a number of cooling devices associated with the external device, an identifying tag associated with at least one of the number of cooling devices, a cooling capability of at least one of the number of cooling devices, a power consumption of at least one of the number of cooling devices, a thermal zone sensor for at least one of the number of cooling devices.

In Example 18, the subject matter of any one of Examples 15-17 can optionally include logic, at least partly including hardware logic, to receive a thermal management instruction to the external device and in response to the request, to modify the operation of a thermal dissipation device in the external device.

In Example 19, the subject matter of any one of Examples 15-18 can optionally include logic, at least partially including hardware logic, configured to receive a signal from the sensor indicating that the electronic device is uncoupled from an external device; and update a thermal management platform for the electronic device to accommodate removal of the thermal dissipation capability data received from the external device.

Example 20 is a controller for an external device comprising logic, at least partly including hardware logic, to detect than an electronic device is coupled to the external device, receive a request for thermal dissipation capability data from the electronic device, and in response to the request, to forward thermal dissipation capability data from the external device to the electronic device.

In Example 21, the subject matter of Example 20 can optionally include an arrangement in which the electronic device couples to the external device via a universal serial bus (USB) interface.

In Example 22, the subject matter of any one of Examples 20-21 can optionally include an arrangement in which the thermal dissipation capability data comprises at least one of a number of cooling devices associated with the external device, an identifying tag associated with at least one of the number of cooling devices, a cooling capability of at least one of the number of cooling devices, a power consumption of at least one of the number of cooling devices, a thermal zone sensor for at least one of the number of cooling devices.

In Example 23, the subject matter of any one of Examples 20-22 can optionally include logic, at least partly including hardware logic, to receive a thermal management instruction to the external device and in response to the request, to modify the operation of a thermal dissipation device in the external device.

In Example 24, the subject matter of any one of Examples 20-23 can optionally include logic, at least partially including hardware logic, configured to receive a signal from the sensor indicating that the electronic device is uncoupled from an external device; and update a thermal management platform for the electronic device to accommodate removal of the thermal dissipation capability data received from the external device.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An electronic device, comprising:
at least one heat generating component;
a thermal management module comprising logic, at least partly including hardware logic, to:
receive a signal from the sensor indicating that the electronic device is coupled to an external device;
receive thermal dissipation capability data from the external device; and
update a thermal management platform for the electronic device to accommodate the thermal dissipation capability data received from the external device.

2. The electronic device of claim 1, wherein:
the electronic device couples to the external device via a universal serial bus (USB) interface.

3. The electronic device of claim 2, wherein:
in response to the signal from the sensor, the thermal management module initiates an inquiry to the external device.

4. The electronic device of claim 3, wherein the inquiry is initiated using a human interface device (HID) protocol via a sideband channel on the USB interface.

5. The electronic device of claim 4, wherein the thermal dissipation capability data comprises at least one of:
a number of cooling devices associated with the external device;
an identifying tag associated with at least one of the number of cooling devices;
a cooling capability of at least one of the number of cooling devices;
a power consumption of at least one of the number of cooling devices;
a thermal zone sensor for at least one of the number of cooling devices.

6. The electronic device of claim 1, wherein the thermal management module comprises logic, at least partly including hardware logic, to:
transmit a thermal management instruction to the external device.

7. The electronic device of claim 1, wherein the thermal management module comprises logic, at least partly including hardware logic, to:
receive a signal from the sensor indicating that the electronic device is uncoupled from an external device; and
update a thermal management platform for the electronic device to accommodate removal of the thermal dissipation capability data received from the external device.

8. A controller for an electronic device comprising logic, at least partly including hardware logic, to:
receive a signal from a sensor indicating that the electronic device is coupled to an external device;
receive thermal dissipation capability data from the external device; and
update a thermal management platform for the electronic device to accommodate the thermal dissipation capability data received from the external device.

9. The controller of claim 8, wherein:
the electronic device couples to the external device via a universal serial bus (USB) interface.

10. The controller of claim 9, wherein:
in response to the signal from the sensor, the controller initiates an inquiry to the external device.

11. The controller of claim 10, wherein the inquiry is initiated using a human interface device (HID) protocol via a sideband channel on the USB interface.

12. The controller of claim 11, wherein the thermal dissipation capability data comprises at least one of:
a number of cooling devices associated with the external device;
an identifying tag associated with at least one of the number of cooling devices;
a cooling capability of at least one of the number of cooling devices;
a power consumption of at least one of the number of cooling devices;
a thermal zone sensor for at least one of the number of cooling devices.

13. The controller of claim 8, further comprising logic, at least partly including hardware logic, to:
transmit a thermal management instruction to the external device.

14. The controller of claim 1, further comprising logic, at least partly including hardware logic, to:
receive a signal from the sensor indicating that the electronic device is uncoupled from an external device; and
update a thermal management platform for the electronic device to accommodate removal of the thermal dissipation capability data received from the external device.

15. An external device for an electronic device, comprising:
a housing;
at least one heat dissipation component disposed within the housing;
a controller comprising logic, at least partly including hardware logic, to:
detect than an electronic device is coupled to the external device;
receive a request for thermal dissipation capability data from the electronic device; and
in response to the request, to forward thermal dissipation capability data from the external device to the electronic device.

16. The external device of claim 15, wherein:
the electronic device couples to the external device via a universal serial bus (USB) interface.

17. The external device of claim 15, wherein the thermal dissipation capability data comprises at least one of:
a number of cooling devices associated with the external device;
an identifying tag associated with at least one of the number of cooling devices;
a cooling capability of at least one of the number of cooling devices;
a power consumption of at least one of the number of cooling devices;
a thermal zone sensor for at least one of the number of cooling devices.

18. The external device of claim 15, further comprising logic, at least partly including hardware logic, to:
receive a thermal management instruction to the external device; and
in response to the request, to modify the operation of a thermal dissipation device in the external device.

19. The external device of claim 15, further comprising logic, at least partly including hardware logic, to:
receive a signal from the sensor indicating that the electronic device is uncoupled from an external device
update a thermal management platform for the electronic device to accommodate removal of the thermal dissipation capability data received from the external device.

20. A controller for an external device comprising logic, at least partly including hardware logic, to:
detect than an electronic device is coupled to the external device;
receive a request for thermal dissipation capability data from the electronic device; and
in response to the request, to forward thermal dissipation capability data from the external device to the electronic device.

21. The controller of claim 20, wherein:
the electronic device couples to the external device via a universal serial bus (USB) interface.

22. The controller of claim 20, wherein the thermal dissipation capability data comprises at least one of:
a number of cooling devices associated with the external external device;
an identifying tag associated with at least one of the number of cooling devices;
a cooling capability of at least one of the number of cooling devices;
a power consumption of at least one of the number of cooling devices;
a thermal zone sensor for at least one of the number of cooling devices.

23. The controller of claim 20, further comprising logic, at least partly including hardware logic, to:
receive a thermal management instruction to the external device; and
in response to the request, to modify the operation of a thermal dissipation device in the external device.

24. The controller of claim 20, further comprising logic, at least partly including hardware logic, to:
receive a signal from the sensor indicating that the electronic device is uncoupled from an external device; and
update a thermal management platform for the electronic device to accommodate removal of the thermal dissipation capability data received from the external device.
